(19) United States
(12) Patent Application Publication
(10) Pub. No.: US 2024/0403728 A1
(43) Pub. Date: Dec. 5, 2024

(54) CONFIDENCE CALIBRATION FOR SYSTEMS WITH CASCADED PREDICTIVE MODELS

(71) Applicant: SRI International, Menlo Park, CA (US)

(72) Inventors: Yunye Gong, West Windsor, NJ (US); Yi Yao, Princeton, NJ (US); Xiao Lin, Fremont, CA (US); Ajay Divakaran, Monmouth Junction, NJ (US)

(21) Appl. No.: 18/614,388

(22) Filed: Mar. 22, 2024

Related U.S. Application Data
(60) Provisional application No. 63/454,568, filed on Mar. 24, 2023.

(51) Int. Cl. G06N 20/20; G06N 7/01

(52) U.S. Cl. CPC G06N 20/20; G06N 7/01

(57) ABSTRACT

In general, techniques are described that address the limitations of existing conformal prediction methods for cascaded models. In an example, a method includes receiving a first validation data set for validating performance of an upstream model of the two or more cascaded models and receiving a second validation data set for validating performance of a downstream model of the two or more cascaded models wherein the second validation data set is different than the first validation set; estimating system-level errors caused by predictions of the upstream model based on the first validation data set; estimating system-level errors caused by predictions of the downstream model based on the second validation data set; and generating a prediction confidence interval that indicates a confidence for the system based on the system-level errors caused by predictions of the upstream model and based on the system-level errors caused by predictions of the downstream model.

This application claims the benefit of U.S. Patent Application 63/454,568, filed Mar. 24, 2023, which is incorporated by reference herein in its entirety.

### GOVERNMENT RIGHTS

This invention was made with Government support under contract number HR001119C0112 awarded by the Defense Advanced Research Projects Agency (DARPA). The Government has certain rights in this invention.

### TECHNICAL FIELD

This disclosure is related to machine learning systems, and more specifically to confidence calibration for systems with cascaded predictive models.

### BACKGROUND

Existing conformal prediction algorithms have limitations when applied to cascaded autonomous systems, sometimes referred to as ensemble learning systems. Such conformal prediction algorithms estimate confidence intervals for individual models. In other words, existing conformal prediction algorithms predict a range of values where a new data point is likely to fall with a certain level of confidence (e.g., 95%). This approach works well for single models but has limitations when applied to cascaded systems with multiple models. Errors from one model can propagate and magnify through subsequent models. Individual model predictions do not necessarily fully capture the final output of the system and the corresponding uncertainty. Confidence intervals built for individual models may not reflect the true uncertainty of the output of the entire system.

### SUMMARY

In general, techniques are described that address the limitations of existing conformal prediction methods for cascaded models. In real-world development, collecting end-to-end system-level data for calibration may be difficult and expensive. Instead of needing complete end-to-end validation data for the entire system, the disclosed techniques utilize validation data from each individual model. The disclosed techniques assume the validation data reflects the “ideal training distribution.” In other words, the disclosed techniques assume that the validation data represents the kind of data the system is expected to encounter in real use. In some examples, the disclosed techniques may leverage conformal prediction algorithms, which build intervals based on estimating the distribution of test errors (also called non-conformity scores).

In some examples, the disclosed techniques may use upstream data and downstream data to estimate the impact of individual model errors on the system-level prediction. The term “upstream data,” as used herein, refers to the input and output pairs for the first model in the system. The term “downstream data,” as used herein, refers to the input and output pairs of the last model in the system. The disclosed techniques may use these individual model error distributions to understand how errors in one model might affect the predictions of subsequent models. By analyzing such individual model data, the disclosed techniques estimate the combined error distribution of the entire system. Using such estimated error distribution, the disclosed techniques construct confidence intervals (also known as “prediction intervals”) that may be calibrated for the entire cascaded system, not just individual models.

Calibrated confidence intervals may not only provide the range but also account for the overall accuracy of the entire cascaded system. A wider confidence interval may suggest the cascaded model is less certain about its prediction, while a narrower confidence interval may indicate higher confidence. For example, if a cascaded medical diagnosis system predicts the likelihood of a disease, a confidence interval may guide doctors. A wide confidence interval may suggest the need for further tests due to model uncertainty, while a narrow confidence interval might provide more confidence in the prediction. In financial forecasting, a calibrated confidence interval for stock prices may help investors understand the potential range of future values and make informed investment decisions considering the associated risk. In autonomous vehicles, confidence intervals around the predicted trajectory may inform the autonomous driving system about the certainty of its path, allowing for safer navigation by accounting for potential uncertainties.

The techniques may provide one or more technical advantages that realize at least one practical application. The disclosed techniques may make the calibration approach more feasible for real-world systems. By considering error propagation, the disclosed techniques provide more reliable and trustworthy performance guarantees for the system. As described herein, users may have greater confidence in the predictions of the system as such predictions may account for the combined uncertainty of all models.

In an example, a method for determining confidence for a system having two or more cascaded models includes receiving a first validation data set for validating performance of an upstream model of the two or more cascaded models and receiving a second validation data set for validating performance of a downstream model of the two or more cascaded models wherein the second validation data set is different than the first validation set; estimating one or more system-level errors caused by predictions of the upstream model based on the first validation data set; estimating one or more system-level errors caused by predictions of the downstream model based on the second validation data set; and generating a prediction confidence interval that indicates a confidence for the system based on the one or more system-level errors caused by predictions of the upstream model and based on the one or more system-level errors caused by predictions of the downstream model.

In an example, a system for determining confidence for a system having two or more cascaded models includes processing circuitry in communication with storage media, the processing circuitry configured to receive a first validation data set for validating performance of an upstream model of the two or more cascaded models and receive a second validation data set for validating performance of a downstream model of the two or more cascaded models wherein the second validation data set is different than the first validation set; estimate one or more system-level errors caused by predictions of the upstream model based on the first validation data set; estimate one or more system-level errors caused by predictions of the downstream model based on the second validation data set; and generate a confidence interval that indicates a confidence for the system based on the system-level errors caused by predictions of the upstream model and based on the system-level errors caused by predictions of the downstream model.

In an example, non-transitory computer-readable storage media having instructions for determining confidence for a system having two or more cascaded models encoded thereon, the instructions configured to cause processing circuitry to: receive a first validation data set for validating performance of an upstream model of the two or more cascaded models and receive a second validation data set for validating performance of a downstream model of the two or more cascaded models wherein the second validation data set is different than the first validation set; estimate system-level errors caused by predictions of the upstream model based on the first validation data set; estimate system-level errors caused by predictions of the downstream model based on the second validation data set; and generate a confidence interval that indicates a confidence for the system based on the system-level errors caused by predictions of the upstream model and based on the system-level errors caused by predictions of the downstream model.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 illustrates the system environment for an example cascaded predictive model system, in accordance with the techniques of the disclosure.

FIG. 2 is a detailed block diagram illustrating an example computing system, in accordance with the techniques of the disclosure.

FIG. 3 is a conceptual diagram illustrating end-to-end system level calibration according to techniques of this disclosure.

FIG. 4 is a conceptual diagram illustrating techniques to estimate the distribution of system-level prediction errors using only model-level data from the training distributions of individual models, in accordance with the techniques of the disclosure.

FIG. 5 is a conceptual diagram illustrating techniques to estimate the distribution of system-level prediction errors using nearest neighbor estimation based on clustering, in accordance with the techniques of the disclosure.

FIG. 6 is a flowchart illustrating an example mode of operation for a machine learning system, according to techniques described in this disclosure.

Like reference characters refer to like elements throughout the figures and description.

### DETAILED DESCRIPTION

Despite recent advancements in data-driven machine learning, especially deep neural network models, achieving high accuracy may not be enough. A major concern may be the inability to reliably guarantee the performance of machine learning models and inability to quantify the uncertainty associated with predictions of the machine learning models. Such lack of guarantees may hinder the safe and trustworthy application of machine learning models in real-world scenarios, especially safety-critical systems, such as, but not limited to, medical diagnosis and autonomous driving. Without knowing how much to trust the predictions generated by machine learning models, making decisions based on the predictions may be risky. Calibration technologies are important to address this issue. Calibration technologies indicate how much users should trust the predictions for decision-making.

As noted above, predicting real-world system behavior may require knowing both accuracy and uncertainty of such predictions. Classic approaches like confidence scores and confidence intervals provide calibration for individual models. Confidence scores measure the probability that a model's prediction is correct. A well-calibrated model may have confidence scores aligned with the true accuracy across different classes or prediction ranges. For example, if a model outputs a confidence score of 80%, the system is expected to be correct about 80% of the time when given similar input data. Confidence intervals capture the uncertainty surrounding predictions of a model. Confidence intervals may provide a range within which the true value is expected to fall with a given probability (coverage probability). Confidence intervals of a well-calibrated model may contain the true value the expected percentage of the time. However, real-world systems often involve cascaded models working together, where errors may propagate and affect overall uncertainty. Existing approaches do not consider how errors combine across models. Existing approaches may underestimate actual uncertainty in cascaded systems. As a result, users may not fully trust system predictions of cascaded models without accurate uncertainty information. Unsafe decisions may be made based on overly optimistic predictions of cascaded models. The present disclosure contemplates calibration techniques that account for error propagation in cascaded systems. The disclosed techniques may improve trust and decision-making in real-world applications.

Many existing approaches assume independent calibration of each model in a cascaded system. In other words, existing approaches ignore error propagation between cascaded models, leading to unreliable system-level confidence measures. Consider a system that predicts a target value and consists of a feature extraction model (first model) and a regression model (second model). Independent calibration may provide accurate confidence for each model's individual predictions. However, errors from the first model may amplify in the second model, leading to inaccurate system-level uncertainty.

Conformal prediction is a technique for building reliable confidence intervals that include the true value with a specific confidence level. Conformal prediction makes very few assumptions about the underlying data distribution. Standard statistical approaches often rely on assumptions like normality, which might not hold true in real-world data. Generally, such lack of assumptions makes conformal confidence intervals particularly robust and reliable, even in scenarios where the data distribution is complex or unknown. Split conformal prediction builds upon the core concepts of conformal prediction and specifically adapts confidence intervals for regression problems where we continuous values are predicted. Split conformal prediction may leverage historical data to learn patterns in the model's errors (residues).

Conformal prediction may consider error propagation across models, providing more accurate system-level confidence measures. Conformal prediction may lead to more reliable predictions and improved trust in the system. Furthermore, conformal prediction offers flexibility with various data distributions and regression models. Recent advancements in conformal prediction may address issues like heteroscedasticity (unequal variance) and covariate shift (changes in input distribution). For single models, covariate shift may be effectively handled as the “true” underlying function and shift of such function is relatively well-defined.

However, the assumption of covariate shift no longer holds when models are developed independently and combined at test time. The “true” function for each model may differ from what the models were trained on. The error propagation due to these individual shifts is not captured by existing approaches.

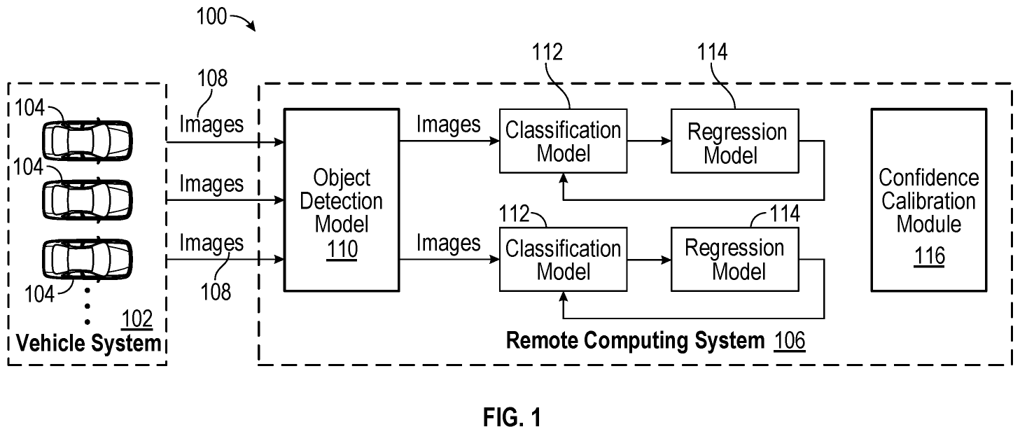

Turning now to the specifics of a system architecture for one application of a cascaded model system, FIG. 1 illustrates the system environment for an example image analysis system 100. Autonomous driving technologies often rely on object recognition and analysis in images, particularly using trained machine learning models. Ability to perform object recognition, detection, identification, and classification in the context of real-world driving events at a large scale plays an important role in developing accurate and efficient automated processes for controlling autonomous and semi-autonomous vehicles, as well as performing other distributed computing and analysis tasks and actions, via real-time image analysis and other suitable analyses.

In the exemplary implementation illustrated in FIG. 1, image analysis system 100 may include a vehicle system 102 and a remote computing system 106. The vehicle system 102 (e.g., vehicle sensor system) may function to record image data during operation of one or more vehicles 104 (e.g., during a driving session). Vehicle system 102 may also function to record image sequences (e.g., video) during vehicle operation. Vehicle system 102 may also function to record external imagery (e.g., via a front-facing camera), and/or to record internal imagery (e.g., via an inward-facing camera). Vehicle system 102 may additionally or alternatively: record auxiliary data (e.g., accelerometer data, Inertial Measurement Unit (IMU) data, Global Positioning System (GPS) data, Real-Time Kinematics (RTK) data, etc.), uniquely identify a vehicle, store data associated with the vehicle (e.g., feature values for frequent drivers of the vehicle, clusters for vehicle drivers, vehicle operation logs, etc.), process the sensor signals into feature values, record driver biometric data (e.g., via a paired wearable device, heartrate data, blood alcohol content values, pulse oximetry data, etc.), and/or perform any other suitable functionality. Vehicle system 102 may implement and/or execute one or more processing modules, and may additionally or alternatively transmit and receive data, instructions, and any other suitable information.

One or more sensors (not shown) of the vehicle system 102 may function to acquire sensor signals (e.g., image data). The sensors may additionally or alternatively acquire auxiliary signals or data over the course of a driving session, acquire signals indicative of user proximity to the vehicle and/or vehicle system, or record any other suitable set of signals and other data. The sensor signals may be timestamped (e.g., with the sampling time), geotagged, associated with the vehicle system identifier, associated with the user identifier, associated with the vehicle identifier, or associated with any suitable set of data. The sensor signals may be immediately analyzed and discarded, stored temporarily on the vehicle system 102 (e.g., cached), stored substantially permanently on the vehicle system 102, sent to the remote computing system 106 or user device, streamed to the remote computing system 106 or user device, or otherwise stored. The set of sensors may include, but are not limited to: cameras (e.g., recording wavelengths within the visual range, multispectral, hyperspectral, InfraRed (IR), stereoscopic, wide-angle, wide dynamic range, etc.), orientation sensors (e.g., accelerometers, gyroscopes, altimeters), acoustic sensors (e.g., microphones), optical sensors (e.g., photodiodes, etc.), temperature sensors, pressure sensors, flow sensors, vibration sensors, proximity sensors, chemical sensors, electromagnetic sensors, force sensors, or any other suitable type of sensor. Vehicle system 102 may include one or more sensors of same or differing type. In one variation, vehicle system 102 includes a camera, wherein vehicle system 102 is configured to mount to a vehicle interior such that the camera is directed with a field of view encompassing a portion of the vehicle interior, more preferably the volume associated with a driver's position but alternatively or additionally a different physical volume.

Vehicle system 102 may be used with one or more vehicles 104, wherein vehicle system 102 may uniquely identify the vehicle 104 that it is currently associated with. In a first variation, vehicle system 102 is specific to single vehicle 104, and may be statically mounted to the vehicle 104 (e.g., within the vehicle, outside of the vehicle, etc.). In a second variation, vehicle system 102 may be associated with (e.g., used across) multiple vehicles 104, wherein vehicle system 102 may be removably coupled to vehicles 104. For example, vehicle system 102 may infer that it is associated with (e.g., located within) vehicle 104 when the measured location is substantially similar to (e.g., within a threshold distance of) the vehicle location (e.g., known or estimated, based on past driving history). However, vehicle system 102 may be otherwise associated with a set of vehicles 104.

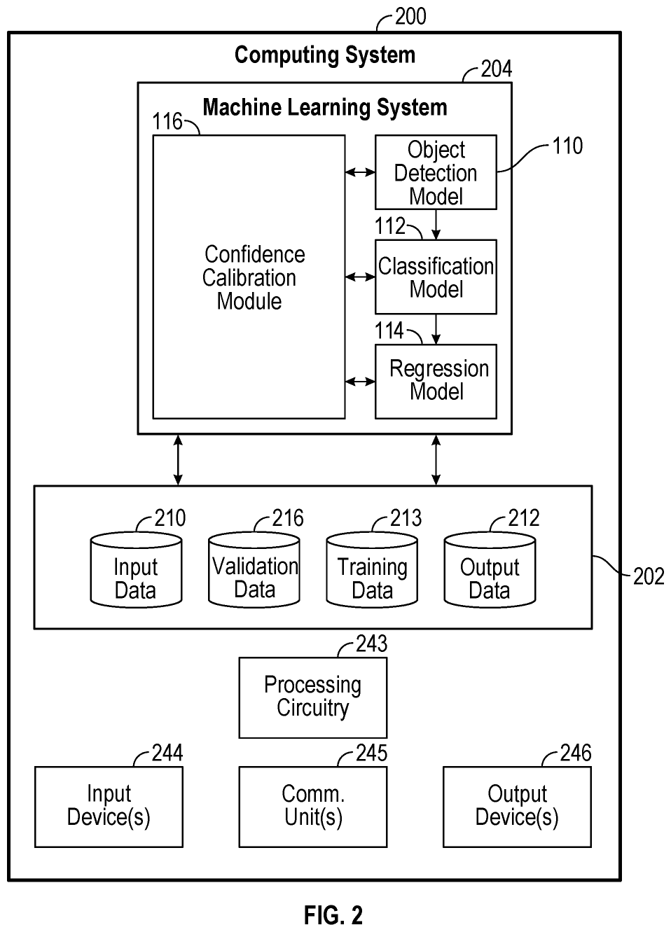

Still referring to FIG. 1, the remote computing system 106 may function as a central management system for one or more vehicle systems 102, users, clients, or other entities. The remote computing system 106 may optionally function as a repository (e.g., central repository) and store user information (e.g., biometric database, preferences, profiles, accounts, etc.), process the sensor signals (e.g., image data), perform all or part of the analyses, implement and/or execute all or a portion of the image processing models, or perform any other suitable computational task. Remote computing system 106 is preferably remote from the vehicle system 102, but may alternatively be collocated with the vehicle system 102 or otherwise arranged. Remote computing system 106 may be a set of networked servers, a distributed computing system, or be any other suitable computing system described below in conjunction with FIG. 2. Remote computing system 106 may be stateful, stateless, or have any other suitable configuration.

The cascaded machine learning models of the remote computing system 106 may be trained to perform object recognition tasks based on image data 108 recorded by the sensors. The set of cascaded machine learning models preferably includes at least one object detection model 110, classification model 112, and regression model 114. The set of cascaded machine learning models may optionally include a tracking model, and any other suitable machine learning model for processing image data 108. The models 110-114 may be cascaded in that the outputs from one model may be used to derive the inputs to a subsequent model. Each of the above models 110-114 may utilize one or more of: supervised learning (e.g., using logistic regression, using back propagation neural networks, using random forests, decision trees, etc.), unsupervised learning (e.g., using an a priori algorithm, using K-means clustering), semi-supervised learning, reinforcement learning (e.g., using a Q-learning algorithm, using temporal difference learning), and any other suitable learning style. Each model of the plurality of models 110-114 may implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, etc.), a Bayesian method (e.g., naïve Bayes, averaged one-dependence estimators, Bayesian belief network, etc.), and any suitable form of machine learning algorithm. Each model 110-114 may additionally or alternatively utilize one or more of: object model-based detection methods (e.g., edge detection, primal sketch, Lowe, recognition by parts, etc.), appearance-based detection methods (e.g., edge matching, divide and conquer, grayscale matching, gradient matching, histograms of receptive field responses, HOG, large modelbases), feature-based detection methods (e.g., interpretation trees, hypothesize and test, pose consistency, pose clustering, invariance), genetic algorithms, background/foreground segmentation techniques, or any other suitable method for computer vision and/or automated image analysis. Each model 110-114 may additionally or alternatively be a: probabilistic model, heuristic model, deterministic model, or be any other suitable module leveraging any other suitable computation method, machine learning method, or combination thereof. The models 110-114 may be cascaded in that the outputs from one model may be used to derive the inputs to a subsequent model.

The object detection model 110 may be trained to detect that an object is depicted in image data 108 (e.g., in an image frame, in an image sequence). In a first variation, the system may include object detection model 110 for each of a predetermined set of object types. In a second variation, the remote computing system 106 may include a global object detection model 110 that detects any of the predetermined set of object types within image data 108. The output of object detection model 110 may include, but is not limited to, bounding boxes (e.g., drawn around all or a portion of the detected object), annotated image data (e.g., with detected objects annotated), feature vectors based on image words (e.g., embeddings), and any other suitable output.

The classification model 112 may be trained to determine a class of an object (e.g., object class) depicted in image data 108. The object class may be determined based on extracted image feature values, embeddings, or any other suitable metric determined by the object detection model 110. In a first variation, classification model 112 may match the embedding values to a vocabulary of image words, wherein a subset of the vocabulary of image words represents an object class, in order to determine the object class of the detected object. In a second variation, remote computing system 106 may include one classification model 112 for each object class, and the object class may be determined by sequentially analyzing the embeddings associated with each object class and then analyzing the results to determine the best match among the classification models 112, thereby determining the object class (e.g., the class corresponding to the classification model 112 whose results best match image data 108). In a third variation, remote computing system 106 may include a cascaded classifier that is made up of hierarchical classification models (e.g., wherein each parent classification model performs a higher level classification than a child classification model). The output of the classification model 112 may include bounding boxes (e.g., drawn around all or a portion of the classified object), annotated image data (e.g., with objects annotated with a text fragment corresponding to an associated object class), feature vectors based on image words (e.g., embeddings), and any other suitable output.

In a first specific example of the classification model 112, remote computing system 106 may include a cascaded sequential classifier wherein a first classification model 112 (e.g., a first model) is executed at the vehicle system 102, and a second classification model 112 is executed at remote computing system 106. In this example, the first classification model 112 may determine an object class for an object depicted in the image data 108, and the second classification model 112 may determine an object subclass for the object.

Regression model 114 may be trained to refine the understanding of the object (e.g., detected objects, classified objects, etc.). Regression model 114 may predict the location (e.g., bounding box around it), size, or even its pose (orientation).

In some variations of the remote computing system 106, the system may include one regression model 114 per object detection model 110 and/or classification model 112. In additional or alternative variations, remote computing system 106 may include a single regression model 114 at which the results and/or outputs of each of the object detection model 110 and/or classification models 112 are refined. However, remote computing system 106 may include any suitable number of regression models 114 having any suitable correspondence to other processing models of the remote computing system 106.

As shown in FIG. 1, remote computing system 106 includes confidence calibration module 116 configured to address certain limitations of existing conformal prediction methods for cascaded models. Standard conformal prediction often relies on paired input-output data for the entire cascaded system (e.g., object detection model 110, classification model 112, and regression model 114), which may be scarce or expensive to obtain. Understanding how errors propagate through the cascade may be important, but directly observing such propagation may be impractical. Existing approaches may struggle to balance coverage guarantees with tight confidence intervals, which may lead to overly conservative predictions by the entire system. Confidence calibration module 116 may focus on analyzing data readily available from individual models (e.g., object detection model 110, classification model 112, and regression model 114) within the cascade. For example, confidence calibration module 116 may analyze error distributions and patterns in each model's predictions. Furthermore, confidence calibration module 116 may analyze correlations between upstream and downstream errors (e.g., correlations between errors produced by object detection model 110 and classification model 112). In one example, confidence calibration module 116 may utilize mathematical frameworks to model how errors accumulate as they progress through the cascade. Such mathematical frameworks may enable confidence calibration module 116 to estimate the impact of upstream errors on the final system output. In a first variation, due to limited paired data, confidence calibration module 116 may estimate upper bounds on the system-level error. Such estimate may guarantee a certain coverage level for the confidence intervals even without complete information. In a second variation, confidence calibration module 116 may employ techniques like K-means clustering that may be used to group data points based on their intermediate features. Such techniques may enable confidence calibration module 116 to identify local patterns of error propagation and refine error estimates for specific prediction scenarios. By incorporating knowledge about error propagation, confidence calibration module 116 may potentially achieve tighter confidence intervals while maintaining the desired level of coverage.

In summary, confidence calibration module 116 may use two separate validation data sets. The first data set may validate the performance of the upstream model, the first model in the cascade (e.g., object detection model 110). The second data set may validate the performance of the downstream model, the model (e.g., classification model 112) receiving the output from the upstream model. Importantly, the two validation data sets may not have a one-to-one correspondence. In other words, the data points in each data set may not be directly related. The upstream and downstream models may have distinct purposes, requiring different validation data. The first model may require raw data (images), while the second model may need processed outputs from the first model (e.g., bounding boxes or object labels). The data used to validate ability of one model to detect objects (upstream) may not be suitable to assess the ability of the downstream model to classify those objects. Next, confidence calibration module 116 may estimate one or more system-level errors caused by each model using their respective validation data. Such estimation may involve analyzing the discrepancies between the predictions of each model and the actual values in the validation data sets. Finally, confidence calibration module 116 may combine the estimated system-level errors from both models to generate a confidence interval for the entire system. The generated confidence interval may represent the range of values within which the true outcome is likely to fall with a certain level of confidence. Confidence calibration module 116 in this way leverages individual model validation to evaluate the accumulated uncertainties in the cascaded system. The disclosed techniques provide a more realistic picture of the prediction confidence of the overall system by incorporating the potential errors introduced at each stage. By understanding how uncertainties accumulate, potential bottlenecks in the cascade may be identified and the design of individual models or the overall architecture may be improved to reduce uncertainty propagation. Based on the analysis of confidence intervals, areas for improvement may be identified in order to make adjustments to enhance precision of the system. For example, model stages with wider confidence intervals may indicate higher uncertainty. This indication may suggest the corresponding models may be contributing more to the overall system's lack of precision. Accordingly, training efforts may be focused on the less precise models within the cascade.

It should be noted that conventional methodology uses a single validation data set for the entire cascaded system (end-to-end system level data). In conventional approaches the confidence of the cascaded model is based on how well the entire system performs on the validation data (e.g., how accurate the final classification or prediction is). The disclosed techniques may be used in place of the conventional methodology when the end-to-end system level data is not available due to practical limitations. The disclosed techniques may also be used in combination with the conventional methodology to obtain a comprehensive view.

While described with respect to a particular set of cascading models for object detection, classification, and verification, the techniques of this disclosure may be applied to analyze and calibrate cascading models in a variety of applications, such as other applications of classification or regression, anomaly detection, recommendation systems, natural language processing (NLP), time series forecasting, fraud detection, and others.

FIG. 2 is a block diagram illustrating an example computing system 200. In an aspect, computing system 200 may represent remote computing system 106 shown in FIG. 1. As shown, computing system 200 includes processing circuitry 243 and memory 202 for executing a machine learning system 204 having a confidence calibration module 116 communicatively coupled to a plurality of cascading models, such as but not limited to, one or more object detection models 110, one or more classification models 112 and one or more regression models 114. The cascading models 110-114 may include any one or more of various types of machine learning models, such as, but not limited to, regression models, classification models, reinforcement learning models, and the like. Although shown as part of a common machine learning system, confidence calibration module 116 may be implemented on a system separate from the cascading models under analysis.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., confidence calibration module 206), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, machine learning system 204 may receive input data from an input data set 210 and may generate output data 212. Input data 210 and output data 212 may contain various types of information, which will generally be tailored to the application/use case for the cascading models. When used in the example system of FIG. 1, input data 210 may include image data 108 obtained by sensors of the vehicle system 102, observations about the environment, and the like. Other types of input data 210 may include other types of sensor data generated by sensors in various fields, such as audio, ranging, temperature, pressure, HVAC, acceleration, GPS, motion, chemical composition, biometric, electrical, proximity, fluid flow, and other sensor data. Other types of input data 210 may include various types of time series data; network data; text including documents, social media posts, emails, or transcripts; financial data; multi-modal data; and so forth. Output data 212 may include information such as, but not limited to (i) upper bounds of system level errors and (ii) confidence intervals.

Machine learning system 204 may process training data 213 to train the cascaded models, in accordance with techniques described herein. For example, machine learning system 204 may apply an end-to-end training method that includes processing training data 213. Training data 213 may include, but is not limited to, labeled or unlabeled image data. As other examples, training data 213 may include types of data similar to those types described above with respect to input data 210 and may be labeled or unlabeled. In one example, machine learning system 204 may randomly split the training data 213 into training data 213 and validation data 216 sets of equal size. It should be noted that cascaded models (e.g. object detection model 110, classification model 112 and regression model 114) are trained separately. Once trained, cascaded models 110-114 may be deployed to process input data 210. In an example, performance and errors generated by the cascaded models may be analyzed by confidence calibration module 116 to estimate the impact of individual model errors on the system-level prediction.

Existing conformal prediction approaches cannot reliably estimate system-level uncertainty in cases where models are independently developed and fused at test time. In an aspect, confidence calibration module 116 may specifically address the challenges of error propagation and combined covariate shifts in cascaded systems. As shown in FIGS. 1 and 2, cascaded systems combine multiple models, where the output of one model becomes the input for the next model in the cascade. In the example illustrated in FIG. 2, the output of object detection model 110 becomes the input of classification model 112, the output of classification model 112 becomes the input of regression model 114, and so on. An imperfect upstream model (e.g., object detection model 110) may introduce two issues that may affect the performance of the entire system and confidence calibration. Errors of the upstream model may change the data distribution seen by the downstream model (e.g., classification model 112), making predictions of such model less accurate. The true value the system should predict (based on system inputs) may differ from the true value the downstream model predicts based on its (shifted) inputs. Even if the downstream model (e.g., classification model 112) perfectly predicts/classifies based on its shifted inputs, the overall predictions and confidence measures of the system may still be inaccurate due to the impact of the upstream model (e.g., object detection model 110). Calibrating confidence in cascaded systems requires considering not just individual model errors, but also how such errors propagate and interact. Simply calibrating each model independently may be insufficient.

Developing large systems in the real world, such as remote computing system 106 illustrated in FIG. 1, typically involves challenges in ensuring reliable confidence intervals. Existing approaches often fail to account for the complex interactions between multiple models within the system, leading to inaccurate and unreliable predictions.

The disclosed techniques propose calibration solutions to address the aforementioned issue. Confidence calibration module 116 may implement such solutions by focusing on generating proper confidence intervals for the entire system, not just individual models 110-114. Confidence calibration module 116 may leverage conformal prediction algorithms, which may use estimates of test errors (non-conformity scores) to construct intervals.

Confidence calibration module 116 specifically tackles the problem of independent model development, where each model is trained separately. Instead of requiring expensive end-to-end system-level data, confidence calibration module 116 utilizes model-level validation data 216. In many cases, model-level validation 216 data is easier and cheaper to acquire during individual model development.

Confidence calibration module 116 may assume the validation data 216 reflects the “ideal training distribution.” In other words, confidence calibration module 116 may assume that the validation data 216 represents the kind of data the system is expected to encounter in real use. By analyzing the error distribution within validation data 216 of each model, confidence calibration module 116 may essentially infer error distribution of the overall system (e.g., remote computing system 106). Confidence calibration module 116 may then use the inferred error distribution to construct accurate confidence intervals without needing the full end-to-end data.

Advantageously, confidence calibration module 116 uses easier and cheaper to obtain model-level validation data as compared to end-to-end data. Confidence calibration module 116 makes the calibration techniques more feasible for real-world systems. In one non-limiting example, if the model-level data accurately reflects the behavior of the system, the inferred error distribution may be reliable.

Confidence calibration module 116 may leverage upstream and downstream data to understand how errors in one model affect the other. In an aspect, confidence calibration module 116 may calculate an upper bound on the true system-level error distribution based on the individual model errors and their interactions. Such upper bound may ensure conservative and safe confidence intervals, but might be wider than necessary.

In an example, based on such upper bound, confidence calibration module 116 may estimate empirical quantiles, which may be used to construct the final confidence intervals. The disclosed techniques may further incorporate clustering of the model-level validation data. Data points may be clustered based on the similarity of upstream outputs (equivalent to downstream inputs). Such clustering may allow for cluster-level estimates of error distributions, which may be more accurate than individual model estimates.

By leveraging cluster-level information, confidence calibration module 116 may potentially generate less conservative confidence intervals that include the true system-level values with higher probabilities. Confidence calibration module 116 may use readily available model-level data to estimate the overall system-level error distribution. Confidence calibration module 116 may employ an upper bound and clustering to achieve safe and potentially more accurate confidence intervals.

In one non-limiting example, calibration module 116 may employ two baselines. Ideal system-level calibration baseline may use split conformal prediction on system-level validation data to represent the best achievable performance under perfect knowledge of the entire system's behavior. Covariate shift calibration baseline may apply existing methods for calibrating individual models with covariate shift (changes in input distribution) on the downstream model only. The results of such comparison may show that confidence calibration module 116 may generate safer confidence intervals. Intervals generated by confidence calibration module 116 are more likely to be valid (covering the true value) compared to the covariate shift calibration baseline.

The gap between the target confidence level and the actual percentage of predictions covered by the interval may be smaller for confidence calibration module 116. Confidence calibration module 116 may outperform the covariate shift baseline, suggesting that confidence calibration module 116 better captures the combined effects of individual model errors and shifts in the system. Furthermore, confidence calibration module 116 may offer improved reliability compared to calibrating individual models independently.

As noted above, conventional approaches for calibrating confidence intervals often fail to consider complex interactions in cascaded systems, leading to unreliable results. Existing approaches often require system-level validation data, which may be expensive and difficult to obtain in real-world applications. Confidence calibration module 116 may allow to make safe and informative predictions about system behavior without needing full system-level validation data. The disclosed techniques may utilize similarities between different model inputs to improve accuracy. Confidence calibration module 116 may estimate an upper bound on the system-level error, ensuring safe and conservative confidence intervals.

Confidence calibration module 116 uses a concept of empirical quantiles. For example, if there is a set of samples (X₁, . . . , Xₙ) from some unknown distribution, ordering such samples from smallest to largest may provide the order statistics X₍₁₎≤ . . . X₍ₙ₎.

As used herein, the term “empirical quantile at a specific probability level (α)” represents the value in the ordered list that separates the bottom α proportion of samples from the top (1−α) proportion. If [(n+1)α] is less than or equal to n (an integer), the quantile is the X_{[(n+1)α]}-th order statistic (e.g., the median is the 0.5 quantile, which is the (n+1)/2-th element for an odd number of samples). Otherwise, the quantile is the co.

Conformal prediction algorithms may use empirical quantiles to construct confidence intervals. Such intervals aim to capture the true value of a future observation with a certain level of confidence. In one example, by estimating the quantiles of the non-conformity scores (a measure of how well a prediction fits the training data), confidence calibration module 116 may build intervals that are guaranteed to cover the true value with a specified probability, even without knowing the exact underlying distribution. The following lemma (1) provides a theoretical justification for using empirical quantiles in conformal prediction:

Lemma (1). If X₁, . . . , Xₙ₊₁ are exchangeable random variables, for any α∈(0;1),

$$P \{ {X}_{n + 1} \leq {Q}_{α} ( \{ {X}_{1} ; … ; {X}_{n} \} ) \} \geq α \qquad ( 1 )$$

Furthermore, if X₁; . . . ; Xₙ₊₁ are almost surely distinct, then

$$P \{ {X}_{n + 1} \leq {Q}_{α} ( \{ {X}_{1} ; … ; {X}_{n} \} ) \} \leq α + \frac{1}{n + 1} \qquad ( 2 )$$

This lemma (1) deals with the empirical quantile Q_{α}({X₁; . . . ; Xₙ})}) of a set of n exchangeable random variables X₁, . . . , Xₙ and the probability that a new random variable Xₙ₊₁ falls within this empirical quantile.

In the lemma (1), one of the assumptions is that X₁, . . . , Xₙ₊₁ are exchangeable. In other words, the order of the random variables does not affect the joint probability distribution. Another assumption is that α∈(0,1), where α is the target confidence level (e.g., 0.9 for 90% confidence).

The claim in lemma (1) is that the probability P {Xₙ₊₁≤Q_{α}({X₁; . . . ; Xₙ})} (the new variable Xₙ₊₁ falls below the αth quantile of the existing set) is greater than or equal to α. If the variables are almost surely distinct (meaning they almost never have the same value), then this probability is actually equal to α.

It should be noted that the αth quantile calculated for a set of samples roughly represents a value that separates the “bottom” α proportion of samples from the rest. The lemma (1) says that, regardless of the order in which samples are drawn, there is at least an α chance that a new sample will fall below this quantile value.

In an example, if the samples are distinct, there is no ambiguity about their order, and the new sample will either fall below or above the quantile, leading to an exact α probability. Conformal prediction algorithms use empirical quantiles to construct confidence intervals. The lemma (1) guarantees that the constructed confidence intervals will cover the true value of a future observation with at least the specified confidence level (α). Such property is important for the reliability and theoretical soundness of conformal prediction techniques described herein.

Conformal prediction is a technique for building confidence intervals that guarantee to cover the true value with a specified probability, even without knowing the exact underlying data distribution. Unlike traditional approaches that rely on model assumptions, conformal prediction is distribution-free and may work with any learning algorithm. In an example, conformal prediction may use, for instance, a set D={(Xᵢ;Yᵢ)}_{i=1 . . . :n}, where D denotes data samples drawn from a joint distribution. The conformal prediction techniques may seek to generate a proper confidence interval for a new unseen sample (Xₙ₊₁; Yₙ₊₁) using a regression model \hat{μ} trained on the data. In an example, there may be a predefined target coverage rate α (e.g., 0.9 for 90% confidence).

Split conformal prediction is a popular and efficient technique for conformal prediction. Split conformal prediction technique may randomly split the data into a training set (Dₜᵣ) and validation set (Dᵥₐₗ) of equal size. The model \hat{μ} may be trained only on Dₜᵣ data. For each sample (Xₙ₊₁, Yₙ₊₁) in validation set Dᵥₐₗ, the split conformal prediction techniques may calculate a non-conformity score S(X, Y). Such non-conformity score may measure how much the predicted value (\hat{μ} (X)) differs from the true value (Y) for each sample. This step may essentially evaluate the prediction error of the model on unseen data.

Next, based on the empirical distribution of non-conformity scores S in Dᵥₐₗ, confidence calibration module 116 implementing the split conformal prediction technique may calculate the empirical quantile Qα(S; Dᵥₐₗ). Such quantile may represent the a-th smallest element in the sorted list of non-conformity scores. For example, if α=0.9 (90% confidence), the quantile would be the 90th percentile of the non-conformity scores. Such quantile may serve as a threshold for identifying “outliers” in terms of prediction errors. Given a new sample (Xₙ₊₁), the predicted value of such sample may be obtained using the model \hat{μ}(Xₙ₊₁).

In an example, the confidence interval may then be defined as C(Xₙ₊₁)=[\hat{μ}(Xₙ₊₁)−Q_{α}(S; Dᵥₐₗ), \hat{μ}(Xₙ₊₁)+Q_{α}(S; Dᵥₐₗ)]. In an example, such interval may consist of all values within a range around the predicted value. The range may be determined by subtracting and adding the quantile value to the predicted value. Samples in the validation set (Dᵥₐₗ) with non-conformity scores below the quantile threshold may be considered outliers and may be excluded from determining the range.

An advantage of such technique is the guaranteed coverage of the true value within the constructed interval, even without knowing the exact data distribution. The coverage guarantee for such constructed confidence intervals is given in the following theorem (1): Theorem 1. If (Xᵢ; Yᵢ) for 1≤i≤n+1 are exchangeable, then

$$P ( {Y}_{n + 1} ∈ C ( {X}_{n + 1} ) ) \geq α \qquad ( 3 )$$

Furthermore, if the nonconformity scores on validation set {S(X;Y)|(X;Y)∈Dᵥₐₗ} are almost surely distinct, then

$$ℙ ( {Y}_{n + 1} ∈ C ( {X}_{n + 1} ) ) \leq α + \frac{1}{\vert {D}_{2} \vert + 1} \qquad ( 4 )$$

The assumption in this theorem is that (Xᵢ, Yᵢ) are exchangeable samples. The joint probability distribution does not change if the order of the samples is swapped.

C(Xₙ₊₁) may be the confidence interval constructed by the split conformal prediction technique described above.

The theorem (1) states that the probability that the true value Yₙ₊₁ of a new sample Xₙ₊₁ falls within the confidence interval C(Xₙ₊₁) is at least α. Such statement is the main coverage guarantee of conformal prediction.

Additionally, if the non-conformity scores in the validation set are almost surely distinct, the probability of the true value falling within the confidence interval is exactly α. Theorem (1) implies a tighter confidence interval in this case.

As noted above, the confidence interval in split conformal prediction is based on the empirical quantile of non-conformity scores in the validation data. The theorem essentially guarantees that a new sample's error will be less than or equal to this quantile with at least probability α. Such property holds due to the exchangeability of the samples and the way the confidence interval is constructed. In an aspect, confidence calibration module 116 may use techniques based on split conformal prediction for challenging system scenarios. Theorem (1) provides a theoretical foundation for the disclosed techniques.

Referring back to FIG. 1, in a non-limiting example, confidence calibration module 116 may calibrate remote computing system 106 consisting of two models (e.g., object detection model 110 and classification model 112) connected in sequence.

The object detection model 110, referred to hereinafter as upstream model (f), may take an input variable X (of dimension m) and may output an intermediate representation Y (of dimension n). The classification model 112, referred to hereinafter as downstream model (g), may take the intermediate output Y from the upstream model and may predict a final output Z (a real number, for example).

Traditional calibration approaches often struggle with cascaded predictions, where the final output depends on the combined errors of both models. Such traditional approaches may lead to unreliable confidence intervals for the final output Z.

As noted above, confidence calibration module 116 may calibrate such multi-model systems with cascaded predictions. Confidence calibration module 116 may perform calibration that aims to ensure that the confidence intervals for the final output Z are accurate and reliable.

As noted above, X may be a m-dimensional input variable to the upstream model. Y may be a n-dimensional intermediate output from the upstream model and input to the downstream model. Real number Z may be the final output of the downstream model. In an example, \hat{f} and ĝ may be learned models approximating the true upstream and downstream processes f and g, respectively. The techniques disclosed herein contemplate that models may be developed independently with data drawn from ideal distributions P_{X,Y} for the upstream model and P_{Y,Z} for the downstream model. Such model training reflects a typical real-world scenario where individual models may be trained in isolation before being integrated into a larger system.

Traditional calibration approaches applied at the model level (e.g., confidence scores for classification, confidence intervals for regression) may not be accurate when the models 110-112 are combined because composing the models may introduce distributional shifts (changes in the data distribution) that the individual model calibrations may not necessarily account for. The models 110-112 may be calibrated well on their own, but their combined predictions may not be reliable due to the aforementioned shifts. In an example, confidence calibration module 116 may consider the interaction and composition of the models 110-112, not just their individual performance. Furthermore, confidence calibration module 116 may address the distributional shifts introduced when combining models 110-112.

More specifically, when combining multiple models in a cascaded prediction system, the actual input distribution to the downstream model may differ from the training distribution of the downstream model because the upstream model's imperfections (deviations from its ideal behavior) may introduce shifts in the data distribution seen by the downstream model. The predictions of the upstream model may deviate from the true values, leading to shifts in the input distribution for the downstream model. The severity of such shifts may depend on the accuracy of the upstream model. More errors in the upstream model may lead to larger shifts.

Additionally, such errors may create discrepancies between the ground truth of the downstream model (true values for its predictions) and the system-level ground truth (true values of the final output). Ground truth discrepancies may further contribute to shifts in the error distribution of the downstream model.

Traditional model-level calibration approaches (calibrating each model independently) may become ineffective due to such distribution shifts. The calibrated models may perform well individually, but their combined predictions may not be reliable. In an example, confidence calibration module 116 may adapt the strategies based on the availability of calibration data. Different assumptions may be made depending on whether system-level data (data covering the entire system's behavior) is available or not. Understanding the aforementioned distribution shifts is important for designing effective calibration methods for cascaded prediction systems.

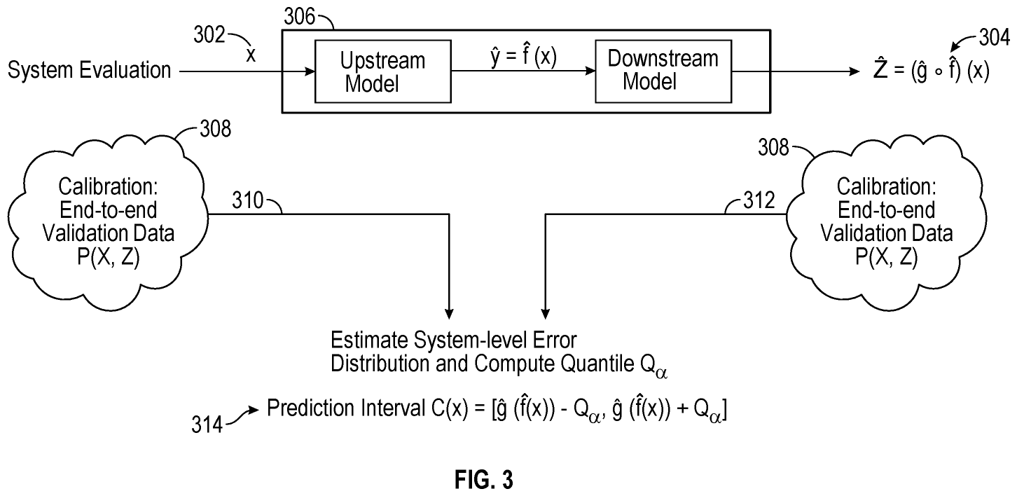

FIG. 3 is a conceptual diagram illustrating end-to-end system level calibration according to techniques of this disclosure. In an example, baseline calibration technique disclosed herein assumes that at least a small amount of “system-level” data is available during the calibration stage.

The system-level data may include both the input X 302 to the system and the final output Z 304 produced, allowing confidence calibration module 116 to supervise the complete end-to-end process. With such system-level data, confidence calibration module 116 may treat the whole cascaded system (ĝ∘\hat{f}) as a single “black box” 306. Confidence calibration module 116 may then apply traditional regression calibration techniques (similar to split conformal prediction) directly to black box 306 to calibrate predictions of the cascaded system. Such calibration technique may be considered “ideal” because confidence calibration module 116 may directly calibrate on how the full system operates, accounting for any distributional shifts or errors introduced by individual models.

Collecting system-level data may involve more time, resources, or complex test setups. There might be situations where capturing the complete input and output for the whole system is simply not feasible. Baseline performance technique may serve as a benchmark. Such technique may establish a target performance level for the system-level calibration, but such calibration might not be practical in all cases.

In summary, confidence calibration module 116 may need to use system-level calibration data to deal with cascaded systems but there might be practical constraints that make such calibration data difficult to obtain.

In an example, when no distributional shifts are assumed at the system level (i.e., the combined effect of both models may be considered stable), the challenges of interaction between models with respect to error and confidence propagation may be ignored. Addressing interaction and ignoring shifts may simplify the problem, allowing confidence calibration module 116 to focus on the end-to-end system as a whole. In an example, confidence calibration module 116 may use the split conformal prediction technique for calibration.

The split conformal prediction technique may generate confidence intervals with guaranteed coverage for arbitrary regression models. The split conformal prediction technique may assume exchangeability of the calibration data. In other words, the order in which the data is drawn does not affect the results. For example, a set of validation data points D_{cal}={(Xᵢ, Zᵢ)} 308 may be drawn from the joint distribution P_{X, Z}. Confidence calibration module 116 may calculate the empirical error distribution S(X; Z).

The calculated error 310 may represent the difference between the actual output (ĝ∘\hat{f} (X)) of the system and the true value (Z). Based on the target coverage rate α, confidence calibration module 116 may compute the empirical quantile Q_{α}(S; D_{cal}) 312. The calculated quantile 312 may be the α-th smallest element in the sorted list of S(X; Z) values in the validation data 308.

The empirical quantile 312 represents the maximum error observed in the validation data 308 with a probability of at least α. Confidence calibration module 116 may use the empirical quantile information 312 to generate confidence intervals for future system outputs, ensuring a certain level of coverage for the true value. The disclosed technique leverages split conformal prediction for system-level calibration under the assumption of no distributional shifts. Given a new test sample Xₜ, confidence calibration module 116 may obtain the system's predicted output (ĝ∘\hat{f})(Xₜ). Confidence calibration module 116 may generate the confidence interval for this new sample using the following equation (5):

$${C}_{E} ( {X}_{t} ) = [ ( \hat{g} ∘ \hat{f} ) ( {X}_{t} ) - {q}_{E , α} , ( \hat{g} ∘ \hat{f} ) ( {X}_{t} ) + {q}_{E , α} ] \qquad ( 5 )$$

where q_{E,α} is the empirical quantile 312 calculated by confidence calibration module 116 earlier, representing the maximum observed error with at least α probability in the validation data 308. Following the principles of split conformal prediction, the generated interval C_{E}(Xₜ) 314 may be guaranteed to cover the true value (Zₜ) of the new sample with a probability of at least α. Such probability may be denoted as: P{Zₜ∈C_{E}(Xₜ))≥α. Additionally, if the end-to-end system-level errors on the calibration set are almost surely distinct (meaning they almost never have the same value), the probability of the true value falling within the interval becomes exactly α:

$$P \{ {Z}_{t} ∈ {C}_{E} ( {X}_{t} ) \leq α + \frac{1}{\vert {D}_{cal} \vert + 1}$$

Here, |D_{cal}| is the number of data points in the calibration set. Confidence calibration module 116 may generate the confidence interval 314 by adding and subtracting the empirical quantile 312 to the system's predicted output for the new sample.

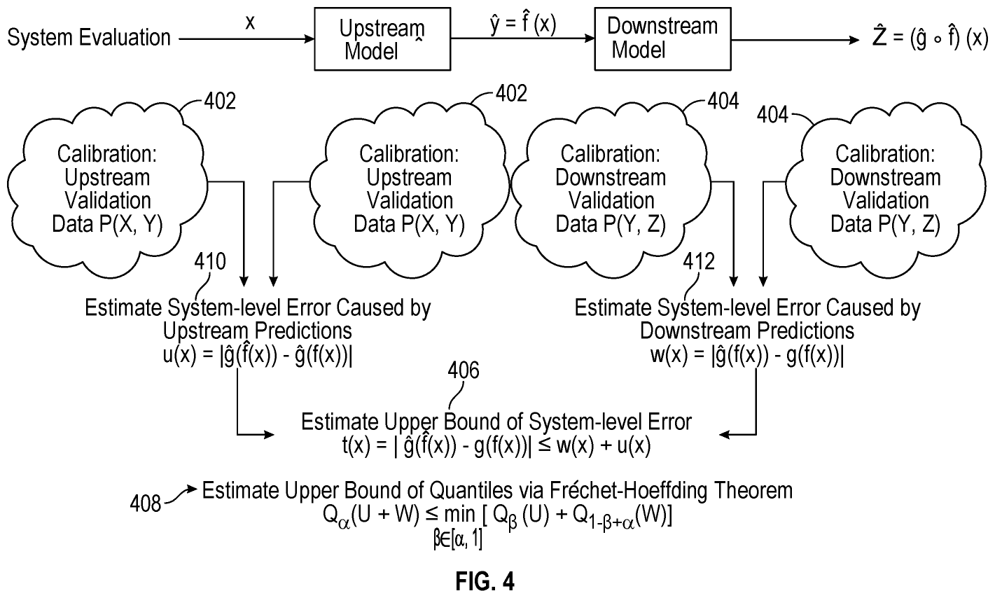

It should be noted that FIG. 3 illustrates system-level calibration assuming the availability of system-level data, which may not be realistic in many scenarios. FIG. 4 is a conceptual diagram illustrating techniques to estimate the distribution of system-level prediction errors using only model-level data from the training distributions of individual models, in accordance with the techniques of the disclosure. The disclosed techniques that may be implemented by confidence calibration module 116 leverage the fact that models, such as object detection model 110 and classification model 112, were previously trained on data drawn from their respective ideal distributions. In other words, the techniques illustrated in FIG. 4 make an assumption that separate validation sets (D_{f} and D_{g}) may be available for the upstream model and downstream model, respectively, drawn from their ideal training distributions. In an example, confidence calibration module 116 may characterize the system-level behavior (including the propagation of errors) without requiring individual data points to be paired between the two models (no need to know which upstream prediction corresponds to which downstream prediction). Furthermore, confidence calibration module 116 may use the upstream validation data (D_{f}) 402 and may calculate the empirical error distribution propagated through the downstream model using the following equation (6):

$$U ( X ; Y ) = \vert ( \hat{g} ∘ \hat{f} ) ( X ) - ( \hat{g} ∘ f ) ( X ) \vert = \vert \hat{g} ( \hat{f} ( X ) ) - \hat{g} ( Y ) \vert . \qquad ( 6 )$$

Equation (6) captures the difference between the actual output of the cascaded system and the output based on the “true” upstream value (not the predicted value). The disclosed techniques build upon this estimated error distribution to construct confidence intervals for the system without requiring system-level data. The disclosed techniques address a practical challenge by leveraging readily available model-level data for system-level calibration. In an example, confidence calibration module 116 may use a metric W(Y; Z) to estimate the downstream prediction error assuming perfect upstream models. Confidence calibration module 116 may calculate W(Y; Z) using the downstream validation data (D_{g}). The calculated metric W(Y; Z) may measure the difference between the output of the downstream model (ĝ(Y)) and the true value (Z). By applying the triangle inequality, the confidence calibration module 116 may relate the system-level error S(X; Z) to the upstream error propagation (U(X;Y)) and the downstream error (W(Y; Z)) using the following equations (7)-(10):

$$S ( X ; Z ) = \vert ( \hat{g} ∘ \hat{f} ) ( X ) - ( g ∘ f ) ( X ) \vert = \vert ( \hat{g} ∘ \hat{f} ( X ) - Z \vert \qquad ( 7 )$$

$$= \vert ( \hat{g} ∘ \hat{f} ( X ) - ( \hat{g} ∘ f ) ( X ) + ( \hat{g} ∘ f ) ( X ) - Z \vert \qquad ( 8 )$$

$$\leq \vert ( \hat{g} ∘ \hat{f} ) ( X ) - ( \hat{g} ∘ f ) ( X ) \vert + \vert ( \hat{g} ∘ f ) ( X ) - Z \vert \qquad ( 9 )$$

$$= U ( X , Y ) + W ( Y , Z ) \qquad ( 10 )$$

Equation (7) defines S(X; Z) as the difference between the actual output of the system (ĝ∘\hat{f} (X)) and the true value (Z). Equation (8) breaks down S(X; Z) into the difference between the output of the system and the “perfect” downstream output (ĝ∘\hat{f}(X)) and the difference between the “perfect” downstream output and the true value. Equation (9) applies the triangle inequality to show that the sum of the absolute values of the two individual error terms is greater than or equal to their absolute difference. Equation (10) substitutes the definitions of U(X, Y) and W(Y, Z) to express S(X, Z) as the sum of U(X, Y) and W(Y, Z). Due to the lack of paired data between the two models, directly calculating the true system-level error distribution is not possible. However, the relationship established in equation (10) suggests that U(X, Y)+W(Y, Z) provides an upper bound 406 for the actual system-level error S(X, Z). Confidence calibration module 116 may use such upper bound 406 to estimate the quantiles (e.g., 90th percentile) of the system-level error distribution, even without directly observing these errors. Confidence calibration module 116 provides an indirect estimate, and the upper bound might be loose depending on the true distribution of errors. According to the techniques disclosed herein, the quantile function (denoted by Q) of the sum of two random variables U and W may be upper bounded by the following equation (11):

$${Q}_{α} ( U + W ) \leq {min}_{β ∈ [ α ; 1 ]} {Q}_{β} ( U ) + {Q}_{1 - β + α} ( W ) ] ] \qquad ( 11 )$$

Equation (11) allows confidence calibration module 116 to estimate an upper bound 408 for the desired quantile of the summed errors (system-level error) based on the quantiles of the individual errors (upstream and downstream). In equation (11), α represents the target coverage probability for the system-level confidence interval.

As discussed above, U and W may represent the upstream error 410 and downstream error 412 estimated earlier using model-level data 402-404. Confidence calibration module 112 may estimate the upper bound quantile for the system-level error using the following equation (12):

$${q}_{M , α} = {min}_{β ∈ [ α ; 1 ]} \vert {Q}_{\_β} ( U , {D}_{f} ) + {Q}_{\_ 1 - β + α} ( W , {D}_{g} ) \vert \qquad ( 12 )$$

Q_{β}(U; D_{f}) and Q_{1-β+α} (W; D_{g}) are the quantiles of the individual errors (U and W) calculated using their respective validation data (D_{f} and D_{g}). β is a parameter that may be adjusted to trade off the tightness of the upper bound and the coverage guarantee. In an example, based on the estimated upper bound quantile q_{M,α}, confidence calibration module 116 may generate a conservative confidence interval for the system-level output of a new test sample Xₜ, using the following equation (13):

$${C}_{M} ( {X}_{t} ) = [ ( \hat{g} ∘ \hat{f} ) ( {X}_{t} ) - {q}_{M , α} , ( \hat{g} ∘ \hat{f} ) ( {X}_{t} ) + {q}_{M , α} ] \qquad ( 13 )$$

In an example, the interval C_{M}(X₁) is conservative because the interval is guaranteed to cover the true value with a probability of at least α due to the upper bound nature of q_{M,α}. The disclosed techniques leverage theoretical results to estimate an upper bound for the true system-level error quantile. In comparison, the C_{E} interval (see equation (5)) was generated using actual system-level errors from the validation data (ideal case assuming data availability).

The C_{M} interval is generated using upper bound estimates based on model-level errors and theoretical bounds (for scenarios without system-level data). Both intervals are essentially guaranteed to cover the true value of the system-level output with a probability of at least the target coverage rate (α). However, the guarantee for C_{M} is weaker as compared to C_{E}. The C_{E} interval utilizes actual system-level errors, leading to a more accurate estimate of the true error distribution and a tighter confidence interval. The C_{E} interval may potentially achieve the exact coverage rate (α) under certain conditions. The C_{M} interval relies on upper bounds for the true error due to the lack of system-level data. Such reliance may lead to a more conservative interval. In other words, the C_{M} might be wider than necessary to guarantee the coverage.

The disclosed techniques prioritize guaranteed coverage even without complete information, at the cost of potentially wider intervals compared to the ideal case.

The choice of calibration technique performed by confidence calibration module 116 may depend on the specific application and requirements of such application.

As noted above, the previously defined upper bound quantile q_{M,α} (Equation 12) may be overly conservative despite guaranteeing coverage because the quantile q_{M,α} relies on worst-case scenarios and may not capture the true distribution of system-level errors accurately.

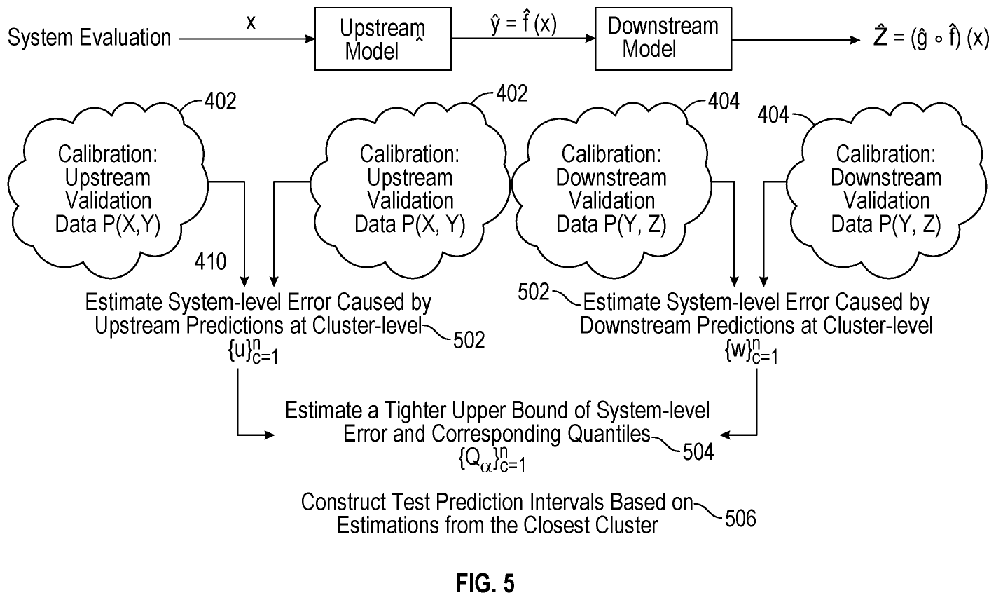

FIG. 5 is a conceptual diagram illustrating techniques to estimate the distribution of system-level prediction errors using nearest neighbor estimation based on clustering, in accordance with the techniques of the disclosure. The nearest neighbor estimation technique may improve the accuracy of the system-level confidence intervals while maintaining the guaranteed coverage.

In an example, while there is no one-to-one correspondence between the two model-level datasets (D_{f} and D_{g}) 402-404, the technique illustrated in FIG. 5 exploits local correspondence based on clustering. It should be noted that confidence calibration module 116 may apply K-means clustering technique to the intermediate features (Y) in the model-level validation data. Confidence calibration module 116 may group data points with similar intermediate features into clusters, potentially revealing local relationships even without direct pairings.

In an example, confidence calibration module 116 may use nearest neighbors within clusters to refine the estimation of system-level errors and generate improved confidence intervals. Such clustering technique addresses the challenges of system-level calibration without system-level data. As noted above, in an example, confidence calibration module 116 may rely on K-means clustering technique applied to the intermediate features (Y) in the upstream validation data (D_{f}) 402. In other words, K-means clustering may result in groups (clusters) of data points with similar intermediate features. By clustering the upstream validation data (D_{f}) 402 based on the intermediate features (Y) confidence calibration module 116 may generate groups of upstream data points.

In an example, each data point in D_{f} may belong to a specific cluster based on Y values of that data point. Since confidence calibration module 116 may perform the clustering on the upstream validation data 402, the confidence calibration module 116 may also determine a corresponding clustering of the upstream predictions. As used herein, the term “corresponding upstream predictions” refers to a grouping the predicted outputs {\hat{f}(Xi)} of the upstream model for the validation data points based on their corresponding cluster in the upstream data. In an example, to establish cluster-level correspondence between the upstream and downstream data, confidence calibration module 116 may employ the Euclidean distance between the cluster centroids in the Y space. Cluster centroids represent the average of data points within each cluster. By calculating the distance between the centroids of corresponding clusters in the upstream and downstream data (based on Y), confidence calibration module 116 may find clusters that potentially share similar characteristics despite lacking direct one-to-one data point correspondence. In other words, confidence calibration module 116 may leverage the clustering structure to establish a meaningful relationship between the upstream and downstream data, even without individual data point pairing.

More specifically, given a new test sample Xₜ, confidence calibration module 116 may utilize nearest neighbor prediction to identify a corresponding cluster in the upstream validation data (D_{f}).

Nearest neighbor prediction for cluster identification may further involve confidence calibration module 116 calculating the Euclidean distance between the upstream prediction of the sample (\hat{f}(X₁)) and the centroids of all upstream clusters. Next, confidence calibration module 116 may identify the cluster D_{f;i} whose centroid has the smallest distance to the prediction of the sample. Based on the identified cluster (D_{f;i}) in the upstream data, confidence calibration module 116 may find the nearest neighbor cluster in the downstream validation data (D_{g}) 404. Identifying nearest neighbor cluster in downstream validation data 404 may involve again confidence calibration module 116 calculating the Euclidean distance between the centroids of all downstream clusters (D_{g,j}) and the centroid of the identified upstream cluster (D_{f;i}). The downstream cluster with the smallest distance may be considered by confidence calibration module 116 to be the nearest neighbor. Confidence calibration module 116 may leverage the identified cluster-level correspondence to estimate the cluster-level error distribution 502. Such estimation may involve confidence calibration module 116 analyzing the errors observed within the corresponding clusters in both the upstream and downstream data. Using the estimated cluster-level error distribution 502 and the chosen target coverage rate (α), confidence calibration module 116 may calculate a quantile 504 using the equation (14) that is similar to previously introduced equation (12):

$${q}_{N , i , j , α} = {min}_{β ∈ [ α ; 1 ]} [ {Q}_{\_β} ( U , {D}_{f , i} ) + {Q}_{\_ 1 - β + α} ( W , {D}_{g , j} ) ] \qquad ( 14 )$$

The quantile (N,i,j,α) represents an improved estimate of the system-level error for the specific cluster-level correspondence.

Finally, using the estimated cluster-level error quantile (N,i,j,α) and the system's prediction for the new sample ((ĝ∘\hat{f})(Xt)), confidence calibration module 116 may generate the system-level confidence interval 506, using equation (15):

$${C}_{N} ( {X}_{t} ) = [ ( \hat{g} ∘ \hat{f} ) ( {X}_{t} ) - {q}_{N ; i ; j ; α} ; ( \hat{g} ∘ \hat{f} ) ( {X}_{t} ) + {q}_{N ; i ; j ; α} ] \qquad ( 15 )$$

In summary, confidence calibration module 116 leverages clustering and nearest neighbors techniques to establish meaningful relationships between upstream validation data 402 and downstream validation data 404 despite lacking direct data point pairing. Confidence calibration module 116 may estimate cluster-level errors based on the identified correspondence, leading to a more refined estimate compared to the previous upper bound based technique discussed above in conjunction with FIG. 4. Confidence calibration module 116 may generate a system-level confidence interval with guaranteed coverage that is potentially tighter than the conservative interval obtained solely from model-level data.

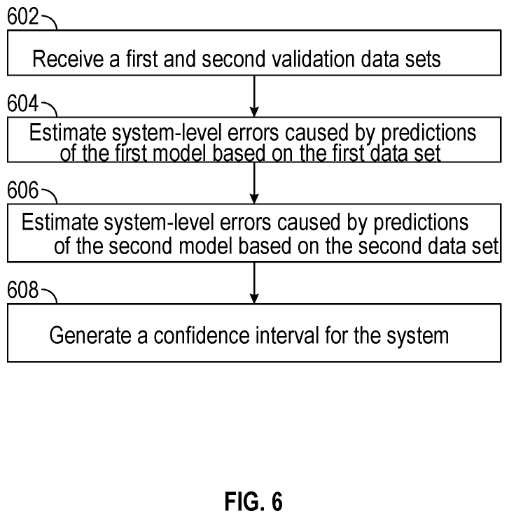

FIG. 6 is a flowchart illustrating an example mode of operation for a machine learning system, according to techniques described in this disclosure. Although described with respect to computing system 200 of FIG. 2 having processing circuitry 243 that executes machine learning system 204, mode of operation 600 may be performed by a computation system with respect to other examples of machine learning systems described herein.

In mode operation 600, processing circuitry 243 executes machine learning system 204. Machine learning system 204 may receive a first validation data set for validating performance of a first model of the system and a second validation data set for validating performance of a second model of the system (602). In an example, the first model may be an upstream model of the two or more cascaded models. Next, machine learning system 204 may estimate system-level errors caused by predictions of the first model based on the first validation data set (604). Machine learning system 204 may also estimate system-level errors caused by predictions of the second model based on the second validation data set (606). Furthermore, machine learning system 204 may generate a confidence interval for the system based on one or more system-level errors caused by predictions of the first model and based on one or more system-level errors caused by predictions of the second model (608). The generated confidence interval may provide a range within which the true value is expected to fall with a given probability (coverage probability).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for determining confidence for a system having two or more cascaded models, the method comprising:
receiving a first validation data set for validating performance of an upstream model of the two or more cascaded models and receiving a second validation data set for validating performance of a downstream model of the two or more cascaded models wherein the second validation data set is different than the first validation set;
estimating one or more system-level errors caused by predictions of the upstream model based on the first validation data set;
estimating one or more system-level errors caused by predictions of the downstream model based on the second validation data set; and
generating a confidence interval that indicates a confidence for the system based on the one or more system-level errors caused by predictions of the upstream model and based on the one or more system-level errors caused by predictions of the downstream model.

2. The method of claim 1, further comprising:
evaluating confidence of the system based on the generated confidence interval; and
adjusting the system to enhance precision of the system.

3. The method of claim 1, wherein the upstream model comprises an object detection model and wherein the downstream model comprises a classification model.

4. The method of claim 1, wherein generating the confidence interval further comprises:
estimating one or more empirical quantiles at a predefined probability level.

5. The method of claim 4, wherein generating the confidence interval further comprises:
determining empirical error distribution for the first validation data set and the second validation data set.

6. The method of claim 5, further comprising:
grouping a plurality of data points in the first validation data set and the second validation data set into two or more clusters based on similarity of intermediate features, wherein the intermediate features comprise intermediate output from the upstream model and input to the downstream model.

7. The method of claim 5, wherein determining empirical error distribution further comprises:
determining cluster-level error distribution.

8. The method of claim 1, wherein generating the confidence interval further comprises generating the confidence interval using a split conformal prediction technique.

9. A computing system for determining confidence for a system having two or more cascaded models, the computing system comprising:
processing circuitry in communication with storage media, the processing circuitry configured to execute a machine learning system configured to:
receive a first validation data set for validating performance of an upstream model of the two or more cascaded models and receive a second validation data set for validating performance of a downstream model of the two or more cascaded models wherein the second validation data set is different than the first validation set;
estimate one or more system-level errors caused by predictions of the upstream model based on the first validation data set;
estimate one or more system-level errors caused by predictions of the downstream model based on the second validation data set; and
generate a confidence interval that indicates a confidence for the system based on the one or more system-level errors caused by predictions of the upstream model and based on the one or more system-level errors caused by predictions of the downstream model.

10. The system of claim 9, wherein the machine learning system is further configured to:
evaluate confidence of the system based on the generated confidence interval; and
adjust the system to enhance precision of the system.

11. The system of claim 9, wherein the upstream model comprises an object detection model and wherein the downstream model comprises a classification model.

12. The system of claim 9, wherein the machine learning system configured to generate the confidence interval is further configured to:
estimate one or more empirical quantiles at a predefined probability level.

13. The system of claim 12, wherein the machine learning system configured to generate the confidence interval is further configured to:
determine empirical error distribution for the first validation data set and the second validation data set.

14. The system of claim 13, wherein the machine learning system is further configured to:
group a plurality of data points in the first validation data set and the second validation data set into two or more clusters based on similarity of intermediate features, wherein the intermediate features comprise intermediate output from the upstream model and input to the downstream model.

15. The system of claim 13, wherein the machine learning system configured to determine empirical error distribution is further configured to:
determine cluster-level error distribution.

16. The system of claim 9, wherein the machine learning system configured to generate the confidence interval is further configured to:
generate the confidence interval using a split conformal prediction technique.

17. A method for determining confidence for a system having two or more cascaded models, the method comprising:
generating a confidence interval that indicates a confidence for the system based on one or more system-level errors caused by predictions of an upstream model of the two or more cascaded models and based on the one or more system-level errors caused by predictions of a downstream model of the two or more cascaded models without using end to end system level data;
evaluating and adjusting the system to enhance precision of the system.

18. The method of claim 17, wherein the upstream model comprises an object detection model and wherein the downstream model comprises a classification model.

19. The method of claim 17, wherein generating the confidence interval further comprises:
estimating one or more empirical quantiles at a predefined probability level.

20. The method of claim 19, wherein generating the confidence interval further comprises:
determining empirical error distribution for the first validation data set and the second validation data set.

21. Non-transitory computer-readable storage media having instructions for determining confidence for a system having two or more cascaded models, the instructions configured to cause processing circuitry to:
receive a first validation data set for validating performance of an upstream model of the two or more cascaded models and receive a second validation data set for validating performance of a downstream model of the two or more cascaded models wherein the second validation data set is different than the first validation set;
estimate one or more system-level errors caused by predictions of the upstream model based on the first validation data set;
estimate one or more system-level errors caused by predictions of the downstream model based on the second validation data set; and
generate a confidence interval that indicates a confidence for the system based on the one or more system-level errors caused by predictions of the upstream model and based on the one or more system-level errors caused by predictions of the downstream model.
